(19) United States
(12) Patent Application Publication
(10) Pub. No.: US 2002/0135310 A1
(43) Pub. Date: Sep. 26, 2002

(54) Single substrate type discharge display device,method of driving the discharge display device and color single substrate type discharge display device

(76) Inventor: Yoshifumi Amano, Kanagawa (JP)

Correspondence Address: William S Frommer, Frommer Lawrence & Haug, 745 Fifth Avenue, New York, NY, 10151, US

(21) Appl. No.: 09/980,002

(22) PCT Filed: Mar. 27, 2001
(86) PCT No.: PCT/JP01/02491

(30) Foreign Application Priority Data
Mar. 27, 2000 (JP) 2000-131820

(51) Int. Cl. G09G 3/10

(52) U.S. Cl. 315/169.3

(57) ABSTRACT

The present invention comprises: first electrodes (2) formed by a plurality of stripe-shaped electrodes formed in parallel to each other on a glass substrate (1); a first dielectric layer (3) formed on the glass substrate (1) so as to cover the first electrodes (2); an insulation layer (4) formed on the first dielectric layer (3), the insulation layer being made of a material that is lower in dielectric constant than the first dielectric layer (3); second electrodes (5) formed by a plurality of stripe-shaped electrodes formed on the insulation layer (4) in parallel to each other so as to cross the plurality of stripe-shaped electrodes forming the first electrodes (2); a plurality of through-holes (7) provided in such positions, in every space between the plurality of stripe-shaped electrodes forming the second electrodes (5), as to respectively correspond to the plurality of stripe-shaped electrodes forming the first electrodes (2) and bored in the insulation layer (4) so as to reach the surface of the first dielectric layer (3); and a second dielectric layer (6) formed on the insulation layer (4) so as to cover the plurality of stripe-shaped electrodes forming the second electrodes (5). As a result, there is obtained a single-substrate type discharge display device that is simple in both of structure and process as compared with a conventional two-substrate type discharge display device, that can be lowered in price owing to remarkable reduction of the number of processes, and that is easy in address discharge using an X-Y matrix as compared with an electrode structure of a conventional single-substrate type discharge display device, and that is capable of lowering the discharge voltage.

### TECHNICAL FIELD

The present invention relates to a Single-Substrate Type Discharge Display Device, Its Driving Method, and Color Single-Substrate Type Discharge Display.

### BACKGROUND ART

A conventional discharge display device (plane type discharge display device) called PDP (Plasma Display Panel) is typically a three-electrode plane discharge display device of two-substrate type including one address electrode on a back-side glass substrate as well as the other address electrode and sustaining electrodes parallel thereto on a front-side glass side.

There is the following method devised for driving a discharge display device having the same structure. In this discharge display device, discharge is made between mutually opposed address electrodes of the respective front-side and back-side glass substrates, while sustaining electrodes are divided into two groups and connected in common. By switching over the voltage, the address discharge is divided to make interlace display.

Furthermore, as a conventional single-substrate type discharge display device, there is one having the structure shown in FIG. 13. In this structure, all of the electrodes which form the aforementioned three-electrode plane discharge device, dielectric layers, and insulation layers are simply formed on the back-side substrate. In other words, lower address electrodes, upper address electrodes, and sustaining electrodes are simply separated by insulation layers.

The discharge display device of FIG. 13 includes first electrodes 2 formed by a plurality of stripe-shaped electrodes formed in parallel to each other on a glass substrate 1, a first dielectric layer 3 formed on the glass substrate 1 so as to cover the first electrodes 2, an insulation layer 4 made of a material that is lower in dielectric constant than the first dielectric layer 3 and formed on the first dielectric layer 3, a second electrodes 5 (including an address electrodes 51 and sustaining electrodes 52) formed by a plurality of stripe-shaped electrodes formed on the insulation layer 4 in parallel to each other so as to cross the plurality of stripe-shaped electrodes forming the first electrodes 2, and a second dielectric layer 6 formed on the insulation layer 4 so as to cover the plurality of stripe-shaped electrodes forming the second electrodes 5.

As an invention applied for patent by the same applicant as the present applicant, there is a two-electrode plane discharge type discharge display device formed so that address and sustaining discharge may he made on the same plane by making two electrodes cross each other and pulling out a lower electrode to the upper surface via a through hole (conductor) as shown in FIG. 12.

The structure of the discharge display device of FIG. 12 will now be described. On the back-side glass substrate 1, X electrodes 2 which are the first electrodes formed by a plurality of stripe-shaped electrodes each having a constant width are deposited and formed at constant intervals in parallel to each other. Subsequently, an insulation layer 4, which covers the X electrodes 2 and insulates the X electrodes 2 from Y electrodes formed later, is deposited and formed over the back-side glass substrate 1 and on the X electrodes 2.

Through-holes are bored in the insulation layer 4 near the Y electrodes 5. A columnar conductor 14 obtained by firing conductive paste is formed in each through-hole. Then, island-shaped electrodes (small electrodes) 15 are deposited and formed on the insulation layer 4 so as to be connected to the top of the conductor 14. The island shaped electrodes 15 are formed concurrently with the Y electrodes 5. Thus, the island-shaped electrodes 15 are electrically connected to the X electrodes 2 through the conductors 14, respectively. On the insulation layer 4, the Y electrodes 5 and the island-shaped electrodes 15 are disposed in parallel with each other. By the way, surfaces of the Y electrodes 5 and the island-shaped electrodes 15 are covered by a dielectric layer 6.

The structure of the front-side glass substrate 11 will be described next. On the front-side glass substrate 11, a plurality of grooves 8 are formed so as to correspond to the X electrodes (the first electrodes) 2 on the back-side glass substrate 1. On internal faces of the plurality of grooves 8 of the front-side glass substrate 11 fluorescent material layers 9 emitting red, green and blue light beams are deposited and formed sequentially and cyclically.

The fluorescent material layers 9 emitting primary color red, green and blue light beams, are deposited and formed directly on internal faces of the grooves 8 of the front-side glass substrate 11. Alternatively, color filters 10 of primary colors, red, green and blue, are deposited and formed on internal faces of the grooves 8, and then the respective corresponding fluorescent material layers 9 of primary colors, red, green and blue, are deposited and formed on the color filters 10 of red, green and blue.

The front-side glass substrate 11 is made to overlap the back-side glass substrate 1 as if the former caps the latter. The glass substrates 1 and 11 are vacuum-sealed together using glass frit or the like. Thereafter, mixed gas suitable for discharge of neon, argon, xenon or the like is sealed into a space between the glass substrates 1 and 11 as discharge gas at approximately 0.5 atm. A plane type display device is thus completed.

In the three-electrode plane discharge type discharge display device of two-substrate type shown in FIG. 12, because there are electrodes on the back-side and front-side glass substrates, fabrication processes increase. Furthermore, because the electrodes formed on the glass substrate of the front face side must have high light transmissivity, fabrication is difficult.

On the other hand, three-electrode plane discharge type discharge display device of single-substrate type as shown in FIG. 13 involves a problem in address discharge. This will be described below referring to FIG. 14 which shows a section of the discharge display device of FIG. 13. The lower address electrode 2 and the upper address electrode 51 make discharge due to the electric field generated in a gap between the upper address electrode 51 and sustaining electrode 52 that are adjacent to each other, and between the address electrodes 51 and 2. As appreciated from this sectional view, however, address discharge is difficult to occur because the insulation layer 4 is thick.

Furthermore, the gap between the upper address electrode 51 and sustaining electrode 52 that are adjacent to each other is typically as narrow as 50 to 100 μm. Therefore, the electric field generated by a voltage applied between the upper electrode 51 and the lower electrode 2 becomes the strongest in the insulation layer directly under the upper address electrode 51 where electrodes cross each other. An electric field sufficient for address discharge cannot be formed in the discharge space.

Moreover, if the aforementioned gap between electrodes is made wide, then the discharge voltage between the electrodes 51 and 52 becomes high and consequently continuance of sustaining discharge will be difficult.

In view of such points, the present invention attempts to propose a single-substrate type discharge display device that is simple in structure, easy in fabrication, and low in price as compared with the conventional two-substrate type discharge display device, that facilities address discharge using an x-Y matrix as compared with the conventional single-substrate type discharge display device, and that is capable of lowering the discharge voltage.

Furthermore, the present invention attempts to propose such a driving method of single-substrate type discharge display device that trigger discharge is made securely and low voltage address driving is possible.

In addition, the present invention attempts to propose such a driving method of single-substrate type discharge display device that the structure of a scanning-side driving circuit can be simplified, thereby allowing its price to be lowered.

Moreover, the present invention attempts to propose such a driving method of single-substrate type discharge display device that trigger discharge can be caused between the address electrode and the first electrodes and so that even if the space between the address electrode and the sustaining electrode is wide, the discharge voltage need not be made high, thus enabling the operation to be stabilized.

Furthermore, the present invention attempts to propose such a driving method of single-substrate type discharge display device that trigger discharge can be caused between the address electrode and the first electrodes, so that even if the space between the address electrode and the sustaining electrode is wide the discharge voltage need not be made high, thus enabling the operation to be stabilized.

Furthermore, the present invention attempts to propose such a high luminance color single-substrate type discharge display device that is simple in structure, easy in fabrication, and low in price as compared with the conventional two-substrate type discharge display device, that facilities address discharge using the X-Y matrix and can lower discharge voltage can be lowered as compared with the conventional single-substrate type discharge display device, that has the structure of the front-side glass substrate of the front face side can be extremely simplified, and that can maximize the ultraviolet irradiation efficiency, i.e., light emission efficiency of the fluorescent material layer while keeping the driving characteristics the best.

### DISCLOSURE OF INVENTION

A single-substrate type discharge display device according to the present invention comprises: first electrodes formed by a plurality of stripe-shaped electrodes formed in parallel to each other on a glass substrate; a first dielectric layer formed on the glass substrate so as to cover the first electrode; an insulation layer formed on the first dielectric layer, the insulation layer being made of a material that is lower in dielectric constant than the first dielectric layer; second electrodes formed by a plurality of stripe-shaped electrodes formed on the insulation layer in parallel to each other so as to cross the plurality of stripe-shaped electrodes forming the first electrodes; a plurality of through-holes provided in such positions in every space between the plurality of stripe-shaped electrodes forming the second electrodes as to respectively correspond to the plurality of stripe-shaped electrodes forming the first electrodes and bored in the insulation layer so as to reach the surface of the first dielectric layer; and a second dielectric layer formed on the insulation layer so as to cover the plurality of stripe-shaped electrodes forming the second electrodes.

In a single-substrate type discharge display device according to the present invention, stripe-shaped electrodes forming the second electrode are comprised pairs of sets of stripe-shaped electrodes, disposed in parallel to each other and electrically connected on the outside.

A driving method of a single-substrate type discharge display device according to the present invention comprised the steps of: using one electrode of a pair of stripe-shaped electrodes on both sided of having the through-holes out of the plurality of stripe-shaped electrodes forming the second electrodes as an address electrode that forms an X-Y matrix in cooperation with the first electrodes, and using the other electrode as a sustaining electrode connected in common to pixels; at time of address discharge, applying scanning address pulses to the address electrodes sequentially, and simultaneously therewith, applying a voltage on such a level as not to start discharge between the sustaining electrode and the address electrode to which the scanning address pulse is applied, to the sustaining electrode, applying an address pulse depending on an image signal to the first electrodes in synchronism with the scanning address pulse to excite discharge, using the discharge as trigger discharge to excite address discharge between the address electrode and the sustaining electrode, and thereby forming wall charges individually for each pixel; and at time of following sustaining discharge, applying a sustaining pulse between the address electrode and the sustaining electrode by utilizing the wall charges formed during the address interval, and thereby continuously exciting sustaining discharge.

A driving method of a single-substrate type discharge display device according to the present invention comprised the steps of: using one electrode of a pair of stripe-shaped electrodes on both sides of through-holes out of the plurality of stripe-shaped electrodes forming the second electrodes as an address electrode that forms an X-Y matrix in cooperation with the first electrodes, using the other electrode as a sustaining electrode connected in common to pixels, connecting the sustaining electrodes in common alternately to first and second connection lines, and thereby dividing the sustaining electrodes into two groups; and at time of address discharge, switching over a voltage applied to the first and second connection lines, thereby selecting which of the two sustaining electrodes adjacent to each address electrode should be discharged, and making interlace display using scanning line interlace driving.

A driving method of a single-substrate type discharge display device according to the present invention comprises the steps of: using one pair of electrodes in two pairs of stripe-shaped electrodes on both sides of the through-holes out of plural pairs of stripe-shaped electrodes forming the second electrode as an address electrodes that forms an X-Y matrix in cooperation with the first electrodes, using the other pair of electrodes as a sustaining electrode connected in common to pixels, connecting the sustaining electrodes in common alternately to first and second connection lines, and thereby dividing the sustaining electrodes into two groups; and switching over a voltage of the first and second connection lines in accordance with timing of a scanning address pulse applied to the address electrode at time of addressing, causing address discharge and sustaining discharge by handling the address electrode and the sustaining electrode as two independent electrodes, and making non-interlace display by sequential scanning driving.

In a driving method of a single-substrate type discharge display device according to the present invention, in a pixel selected by address discharge, sustaining discharge is performed between the address electrode serving as a Y electrode and the sustaining electrode serving as a Z electrode, which are parallel to each other, in a sustaining discharge interval following the address interval. In the sustaining interval, a voltage of the first electrode serving as an X electrode is kept at the same voltage as that of the sustaining electrode or the same sustaining pulse is applied to the first electrode to excite trigger discharge that assists the sustaining discharge between the address electrode and the sustaining electrode.

A color single-substrate type discharge display device according to the present invention comprises: first electrodes formed by a plurality of stripe-shaped electrodes formed in parallel to each other on a back-side glass substrate a first dielectric layer formed on the back-side glass substrate of back face side so as to cover the first electrodes; an insulation layer formed on the first dielectric layer, the insulation layer being made of a material that is lower in dielectric constant than the first dielectric layer; second electrodes formed by a plurality of stripe-shaped electrodes formed on the insulation layer in parallel to each other so as to cross the plurality of stripe-shaped electrodes forming the first electrodes; a plurality of through-holes provided in such positions, in every space between the plurality of stripe-shaped electrodes forming the second electrodes, as to respectively correspond to the plurality of stripe-shaped electrodes forming the first electrodes and bored in the insulation layer so as to reach the surface of the first dielectric layer; a second dielectric layer formed on the insulation layer so as to cover the plurality of stripe-shaped electrodes forming the second electrodes; and a front-side glass substrate opposed to the back-side glass substrate, wherein a plurality of stripe-shaped or grid-shaped grooves are formed on the front-side glass substrate by working the glass substrate itself, and a fluorescent material layer for emitting light of a color corresponding to each pixel is formed on an internal wall face of each groove.

### BRIEF DESCRIPTION OF DRAWINGS

FIG. 1 is a developed oblique view showing a cell structure of a first embodiment according to the present invention;

FIG. 2 is a developed oblique view showing a cell structure of a second embodiment according to the present invention;

FIG. 3 is a developed oblique view showing a cell structure of a third embodiment according to the present invention;

FIG. 4 is a sectional view showing a cell structure of each embodiment according to the present invention;

FIG. 5 is an electrode wiring diagram of the first embodiment according to the present invention;

FIG. 6 is an electrode wiring diagram (1) of the second embodiment according to the present invention;

FIG. 7 is an electrode wiring diagram (2) of the second embodiment according to the present invention;

FIG. 8 is a timing chart (1) of driving pulses;

FIG. 9 is a timing chart (2) of driving pulses;

FIG. 10 is a timing chart (3) of driving pulses;

FIG. 11 is a developed oblique view showing a ninth embodiment according to the present invention;

FIG. 12 is a developed oblique view showing a single-substrate type two-electrode plane discharge display device of invention applied for patent by the same applicant as that of the present application;

FIG. 13 is a developed oblique view showing a conventional single-substrate type three-electrode plane discharge display device; and

FIG. 14 is a sectional view of the conventional single-substrate type three-electrode plane discharge display device of FIG. 13.

### BEST MODE FOR CARRYING OUT THE INVENTION

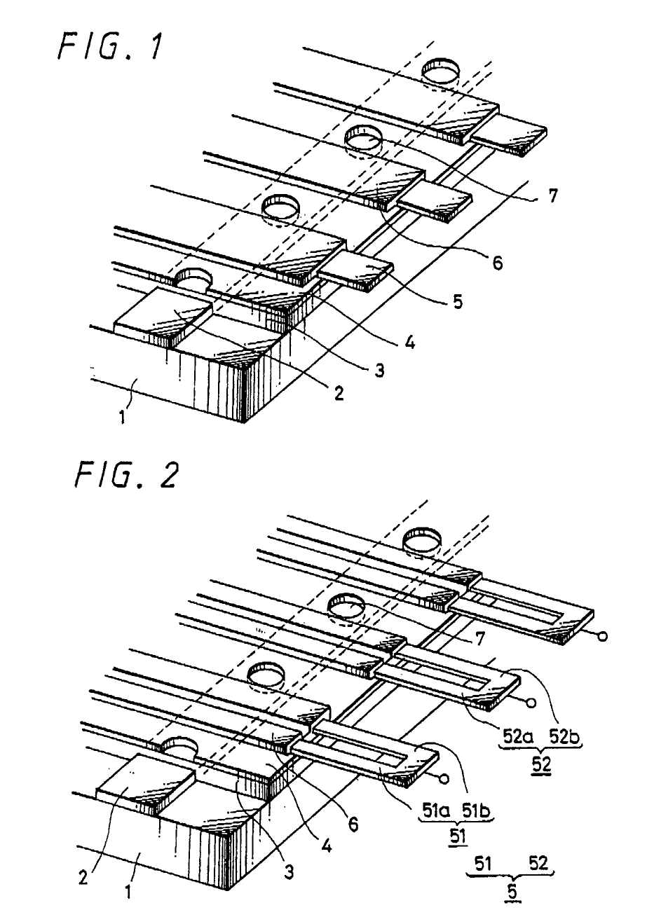

The structure of a single-substrate type discharge display device of a first embodiment according to the present invention will be described below with reference to a developed oblique view of FIG. 1 and a sectional view of FIG. 4, which show its cell structure. A characteristic structure of the discharge display device according to the present invention resides in through-holes 7 provided in an insulation layer 4. The through-holes 7 will be described together with structures of respective components in turn.

First of all, on the back-side glass substrate 1, there is formed first electrodes 2 formed by a plurality of stripe-shaped electrodes having a fixed width, extending in the longitudinal direction and disposed in parallel to each other at fixed intervals. The first electrodes 2 are formed easily by, for example, screen-printing paste-like ink of silver or nickel, etc. on the back-side glass substrate 1 and firing it at, for example, approximately 570° C.

Next, in a range corresponding to the screen, on the back-side glass substrate 1 i.e. in the range for forming pixels thereon, a first dielectric layer 3 is formed so as to cover the first electrodes 2. The first dielectric layer 3 is formed by, for example, screen-printing on a low- melting-point glass or the like having a relatively high dielectric constant, firing it, and forming it into a thickness of approximately 10 to 30 μm.

Next, on the first dielectric layer 3, an insulation layer 4 is formed so as to be piled thereon. At this time, in the case where, for example, the insulation layer 4 is formed like a pattern using the screen-printing method, the through-holes 7 are formed in positions shown in FIG. 1 at the same time.

Moreover, in the case where the insulation layer 4 is formed solidly using a method such as coating, the through-holes 7 are formed in predetermined positions using a method such as the sand blast.

The material of the insulation layer 4 is the same as that of the aforementioned first dielectric layer 3. However, in order to increase the insulation breakdown voltage and decrease the capacitance between electrodes, the thickness of the insulation layer 4 is made thicker than the first dielectric layer 3, and set at, for example, a value in the range of approximately 60 to 100 μm. In addition, a material that has a dielectric constant lower than that of the first dielectric layer 3 is chosen.

Second electrodes 5 are formed on the aforementioned insulation layer 4 so as to cross at right angles the underlying first electrodes 2 to form an X-Y matrix. As to the formation method, the second electrodes 5 can be formed easily using a screen-printing method similar to the formation method of the first electrodes 2. However, the vacuum deposition method or the photosensitive film method may also be used.

The second electrodes 5 are covered by a second dielectric layer 6. Finally, although not illustrated, the whole surface of the first and second dielectric layers 3 and 6 as well as the through-holes 7 formed as described above are covered by a protection layer of magnesium oxide or the like. The discharge display device is thus completed.

Although not illustrated in FIG. 1, the single-substrate type discharge display device is completed by providing a front-side glass substrate, opposing the back-side glass substrate 1 to the glass substrate with uniform spacing, vacuum-sealing their periphery using glass frit, and sealing mixed gas such as neon, argon, and xenon required for gas discharge into the inside.

The structure of a single-substrate type discharge display device according to a second embodiment according to the present invention will be described next with reference to FIG. 2, which shows a cell structure thereof. The basic structure and most of the formation method of respective components are similar to those of the discharge display device of the first embodiment. However, the discharge display device of FIG. 2 is different from the discharge display device of FIG. 1 in that each of stripe-shaped electrodes forming the second electrodes 5 is made up a pair of sets of stripe-shaped electrodes to each other and electrically connected on the outside. The second electrodes 5 is comprised of address electrodes 51 and sustaining electrodes 52 disposed alternately. Between the electrodes 51 and the sustaining electrodes 52, the through-holes 7 are formed in positions corresponding to first electrodes 2.

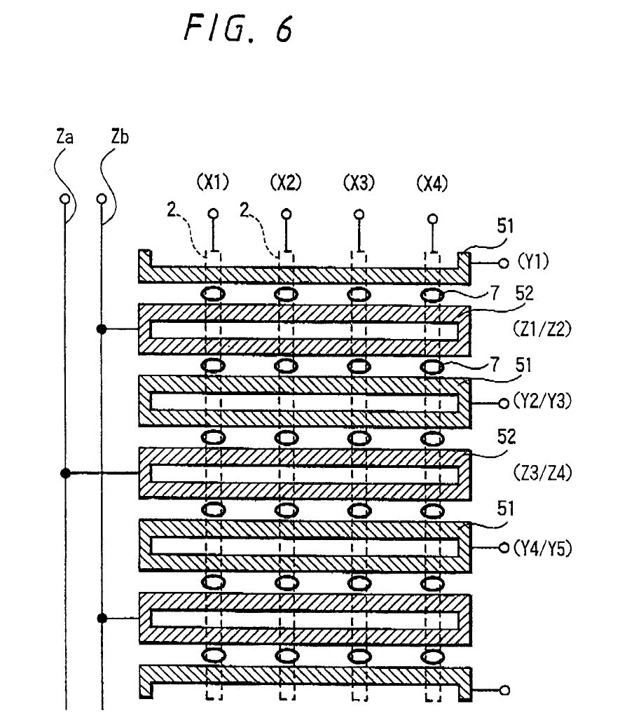

An electrode wiring diagram in this case is shown in FIG. 6. Plural pairs of stripe-shaped electrodes forming the second electrodes 5 operate alternately as address electrodes 51 and sustaining electrodes 52. Wiring of the electrodes and a driving method of the discharge display device will be described later as a seventh embodiment.

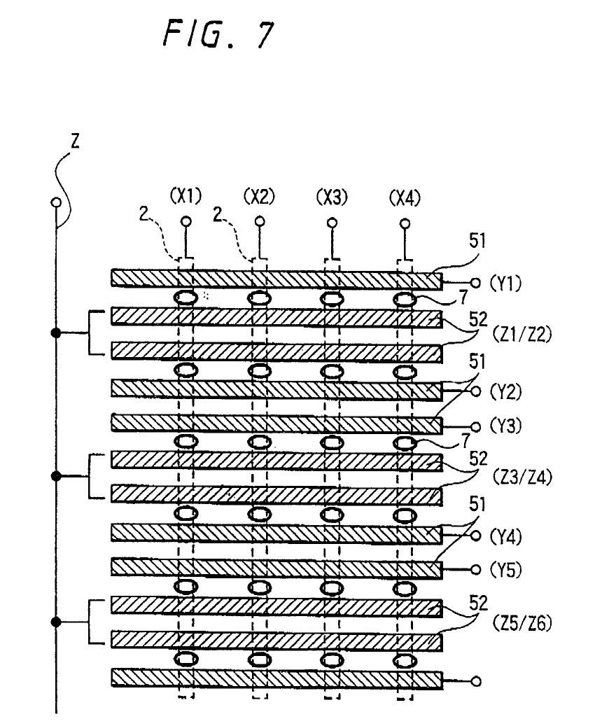

As to the wiring method of two stripe-shaped electrodes disposed on both sides of the through-holes 7, wiring as shown in FIG. 7 is also possible. This will also be described later. In this case, the address electrodes 51 are driven individually and every pair of sustaining electrodes 52 are wired in common. Thus, as compared with the wiring of FIG. 6, higher operation stability is obtained.

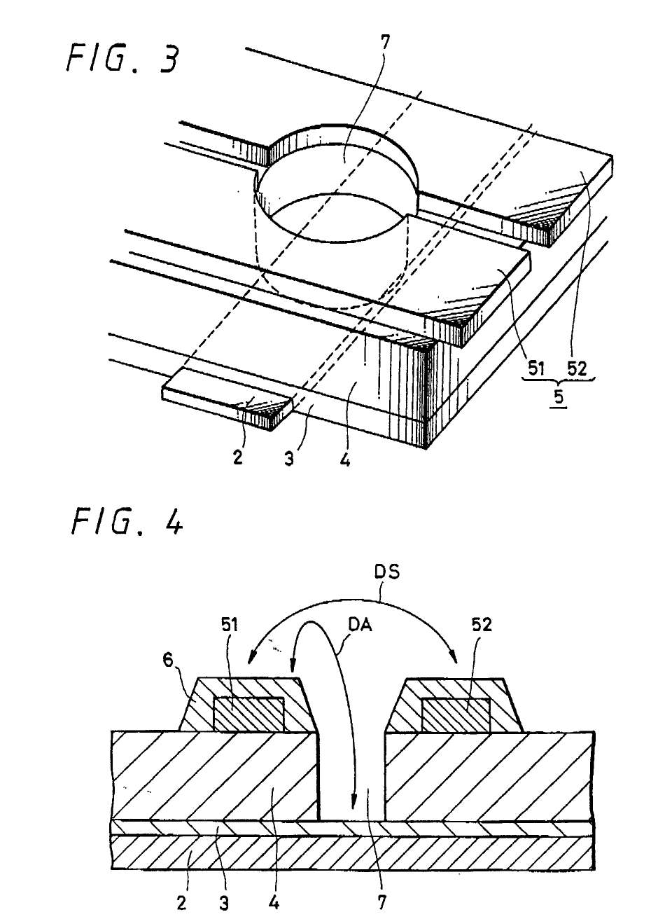

The structure of a discharge display device of a third embodiment according to the present invention will be described next with reference to FIG. 3 which shows a cell structure thereof. The structure of the third embodiment is different in the structure of the second electrodes 5 and the through-holes 7 form the aforementioned first and second embodiments.

As shown in FIG. 3, the structure of the discharge display device of the third embodiment is characterized in that the address electrode 51 and the sustaining electrode 52 forming as the second electrode 5 on both sides of the through-hole 7 are disposed so as to surround the periphery of the opening portion of the through-hole 7.

Although not illustrated in FIG. 3, all of the aforementioned electrodes are further covered by a protection layer made of magnesium oxide and the like together with the second dielectric layer 6 shown in FIGS. 1 and 2. In this case, the interval between the electrode 51 and 52 becomes shorter than the diameter of the through-hole 7.

The structure of a single-substrate type discharge display device of a fourth embodiment according to the present invention will be described next with reference to FIG. 1. This fourth embodiment relates to the size and operation of the through-hole 7 in the aforementioned first, second and third embodiments.

The discharge display device of the fourth embodiment is characterized in that the effective discharge area of the lower address electrode, i.e., the first electrode 2 determined by the area of the opening portion of the through-hole 7 is made smaller than the effective discharge area of the second electrodes 5 on both sides of the through-hole 7.

In the aforementioned first, and second embodiments except the third embodiment of FIG. 3, because the through-hole 7 is provided between electrodes, the spacing between the address electrode 51 and the sustaining electrode 52 becomes inevitably larger than the discharge space of the ordinary discharge display device, of approximately 100 μm and reaches, for example, a value in the range of approximately 300 to 500 μm.

This means that the discharge voltage goes very high, which poses a great problem in driving. In the meantime, the through-hole 7 is located in the middle of the electrodes 51 and 52. The through-hole 7 can be brought closer to either of the electrodes 51 and 52. Therefore, the discharge voltage between the first electrode 2 and the second electrode 5, i.e., the electrode 51 or 52 is lower than the discharge voltage between the electrodes 51 and 52.

If a minute discharge, i.e., trigger discharge is first generated between the electrode 2 and the electrode 51 by utilizing the above fact, then discharge between the electrodes 51 and 52 becomes possible with a lower voltage.

On the other hand, however, the trigger discharge must strictly be a minute discharge. If the wall charge has been formed between the electrode 51 and the electrode 2, then the main discharge between the electrodes 51 and 52 will not occur.

To solve this problem, it is conceived that the effective discharge area of the first electrode 2 is made smaller than the effective discharge area of the second electrode 5 by making the area of the opening portion of the through-hole 7 smaller or by making the electrode width of the first electrode 2 narrower than the electrode width of the second electrode 5. By doing so, only minute wall charges are stored on the surface of the first electrode 2, and so the trigger discharge can be made small. By the way, this object can also be attained by making the thickness of the first dielectric layer 3 thicker. In this case, however, the trigger discharge voltage also goes higher.

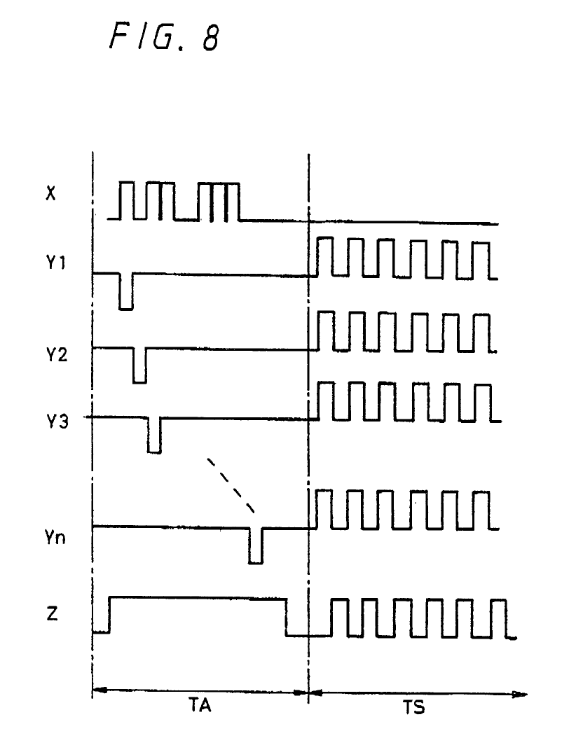

Next, a driving method of a single-substrate type discharge display device forming a basic driving method of discharge display devices of the first to fourth embodiments will be described as a fifth embodiment to a sectional view of FIG. 4 and a timing chart of driving pulses of FIG. 8. Referring to FIGS. 4 and 8, for example, in an address interval TA, voltage pulses of positive and negative voltages sufficient for starting discharge are applied to a selected lower address electrode X1, i.e., the first electrode 2 and an upper address electrode Y1, i.e., the address electrode 51 forming as the second electrode 5, respectively.

At this time, between a sustaining electrode Z, i.e., the second electrode 52 and the address electrode Y, i.e., the address electrode 51 forming also the second electrode, a voltage on such a level that discharge will not occur between both electrodes is applied.

If the aforementioned address pulses are applied and discharge occurs between the electrodes 2 and the electrodes 51, then the discharge space between the address electrodes 51 and the sustaining electrodes 52 is filled with charged particles and quasi-stable atoms. Therefore, discharge occurs immediately here. In other words, this discharge, i.e., the aforementioned discharge between the X and Y electrodes becomes a trigger of the discharge between the address electrodes 51 and the sustaining electrodes 52.

If the address discharge has thus occurred, then wall charges are formed on the dielectric layer 6 over the electrodes 51 and the electrodes 52. As a matter of course, wall charges are not formed on electrodes of which the address discharge has not occurred. Consequently, wall charges depending on an image can be formed.

Thus, in a sustaining discharge interval TS following the address interval TA, sustaining pulses are applied between the address electrodes 51 and the sustaining electrodes 52 utilizing the aforementioned wall charges formed during the address interval TA. This allows sustaining discharge to continue.

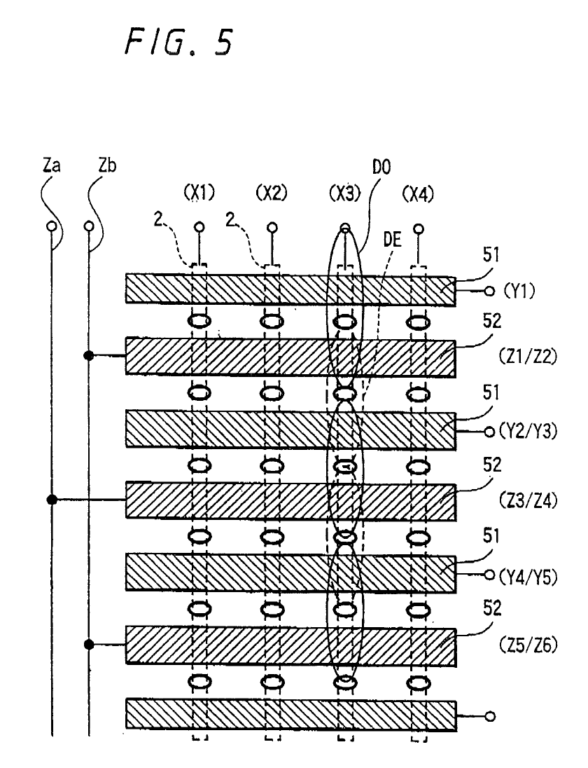

A driving method a of discharge display devices of the first to fourth embodiments, particularly the discharge display device that is wired as shown in FIG. 5 with the electrode structure of FIG. 1 will be described next as sixth embodiment. This is a method of composing a picture by dividing one picture into two fields of odd number and even number in the same way as interlace driving of ordinary television (TV). Now, electrode wiring and the driving method will be described with reference to the wiring diagram of FIG. 5 and the timing chart of driving pulses of FIG. 8.

Referring first to FIG. 5 which is a wiring diagram, the first electrodes 2 are a signal-side address electrodes. This is represented as X1, X2, X3, - - - . The second electrodes 5 include address electrodes 51 and sustaining electrodes 52 on the scanning-side, which are represented as (Y1), (Y2/Y3), (Y4/Y5), - - - , and (Z1/Z2), (Z3/Z4), (Z5/Z6), - - - , respectively. Further, the sustaining electrodes 52, i.e., (Z1/Z2), (Z3/Z4), (Z5/Z6), - - - are connected in common to connection lines Za and Zb alternately. The reason for representation such as (Y2/Y3) is that one electrode is divided into two electrodes operating as discharge electrodes.

Referring to FIG. 8 together with FIG. 5, in the case where, for example, the signal-side electrode X3 is selected during the address interval TA and a display is made between the scanning-side electrodes (Y2/Y3) and (Z1/Z2) the operation is completely the same as that described with the foregoing description of the fifth embodiment. Specifically, discharge occurs between the electrode X3 and the electrode (Y2/Y3) through the through-hole 7. By taking this as a trigger, discharge occurs between the electrode (Y2/Y3) and the electrode (Z1/Z2). Since, at this moment, the connection line Zb connected to the electrode (Z1/Z2) is selected and a voltage is applied thereto, discharge does not occur in the direction the electrode (Z3/Z4) connected to the connection line Za.

In other words, the direction of discharge is determined depending on which of the connection lines Za and Zb is connected to the Z electrodes, i.e., the sustaining electrodes 52 of the second electrodes 5 when scanning pulses are applied to the Y electrodes, i.e., address electrodes 51 of the second electrodes 5.

Thus, by conforming of supply timing the scanning pulses to the Y electrodes with the select timing of the connection lines Za and Zb, it will be possible to select either discharge DE of an even numbered field represented by an ellipse of a broken line in FIG. 5 or discharge DO of an odd numbered field represented by an ellipse of a solid line. In this case, an electrode can be utilized extending over the upper and lower pixels. Therefore, the resolution looks as if it were doubled. As compared at the same resolution, the drive circuits can be decreased.

By the way, as to the method of switching over of the connection lines Za and Zb for selecting the direction of discharge, it will be sufficient for example, select the connection line Zb and scan for the while the address electrodes 51 every other electrode like the electrode (Y1)→(Y4/Y5)→(Y8/Y9)→, then select the connection line Za and scan like the electrode (Y2/Y3)→(Y6/Y7). Alternatively, the connection lines Za and Zb may be selected alternately while scanning in turn like the electrode (Y1)→(Y2/Y3)→(Y4/Y5)→.

A driving method of the discharge display device of the second embodiment as a seventh embodiment will be described next with reference to an electrode wiring diagram of FIG. 6. In the driving method of the aforementioned sixth embodiment, reduction of the driving circuits is aimed by using, for example, a method of assigning the sustaining discharge of one electrode to upper and lower electrodes every field in FIG. 6, i.e., by using interlace driving. In the seventh embodiment described hereafter, each electrode is bisected and handled as if it were two electrodes reduction of the circuit scale without using the interlace driving.

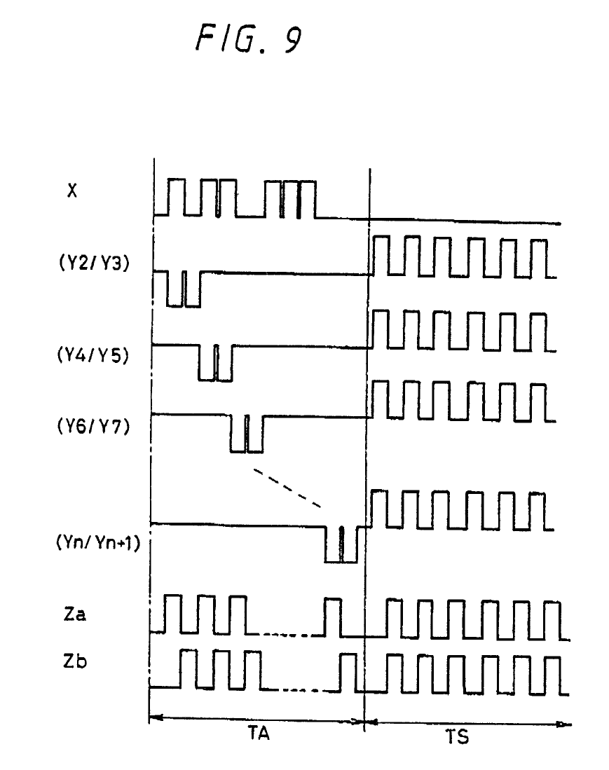

In order to describe the driving method of the seventh embodiment, the electrode wiring diagrams of FIGS. 6 and 7 as well as a timing chart of driving pulses of FIG. 9 are referred to. Basic structures of electrodes of FIGS. 6 and 7 have already been described with respect to the second embodiment.

To be specific, it embodiment is characterized in that each pair set stripe-shaped electrodes forming the second electrodes 5 are disposed on both sides of the through-holes 7, and the pair of stripe-shaped electrodes are wired outside the screen. Electrode wiring of this structure is absolutely the same as that of FIG. 5. In FIGS. 6 and 7, therefore, portions corresponding to those of FIG. 5 are denoted by the same characters, and repeated description will be omitted.

However, because a pair address electrodes is divided into two parts, wall charges generated by the address discharge are formed only on one electrode of the side where discharge has occurred although the two parts are wired in common.

Therefore, display can be made sequentially without performing interlacing by scanning in turn the scanning-side address electrodes, i.e., scanning like the electrode (Y1)→(Y2/Y3)→(Y4/Y5)→, and switching over the connection lines Za and Zb alternately.

FIG. 9 is a timing chart of driving pulses showing an example of the driving method of the discharge display device as the seventh embodiment. In this case, scanning pulses are applied twice to each electrode, and the connection lines Za and Zb. As a result, all cells corresponding to the X electrodes can be addressed in turn. It is a matter of course that driving can also be performed as well by scanning in turn by scanning once to each electrode as usual while keeping the sustaining side at the voltage of connection line Za, without shifting to the sustaining discharge and scanning in turn once again after switching the sustaining side to the connection line Zb.

An eighth embodiment of a driving method of the discharge display devices of the first to fourth embodiments will be described below. This is a driving method of the discharge display device of the second embodiment in which the through-holes 7 are provided between adjacent ones of a plural pair of stripe-shaped electrodes (each pair includes two stripe-shaped electrodes) that form the second electrode 5. In this case also, the second electrodes 5 are comprised of alternately disposed address electrodes 51 and sustaining electrodes 52.

In this driving method, a minute trigger discharge is caused between the scanning-side address electrodes 51 and the first electrodes 2 in the sustaining interval also prior to the discharge with the sustaining electrodes 52, in order to solve the problem that the discharge between the scanning-side address electrodes 51 and the sustaining electrode 52 located on both sides of the through-holes 7 is hard to occur.

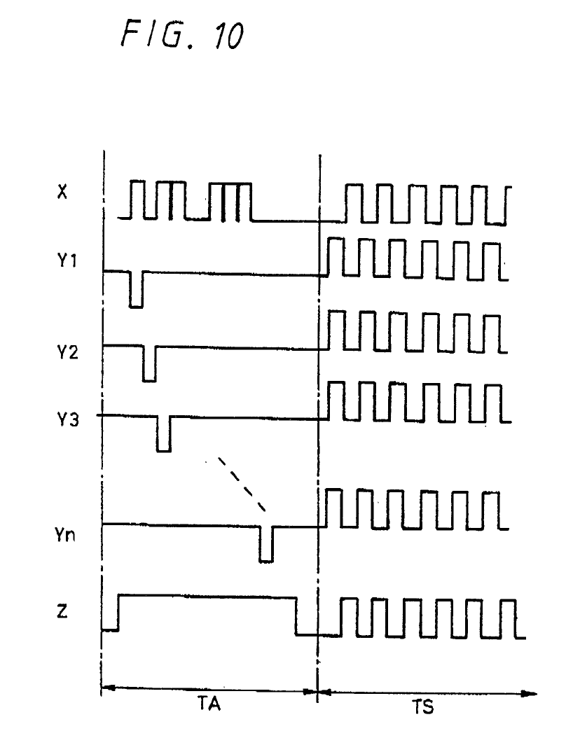

The driving method of this eighth embodiment will be described below with reference to a timing chart of driving pulses of FIG. 10. Sustaining pulses which have heretofore been not applied are applied to the X electrodes of FIG. 10, i.e., the signal-side address electrodes forming as the first electrodes 2. By doing so, the sustaining discharge is generated not only between the Y electrodes, i.e., the scanning-side address electrodes 51 and the sustaining electrodes 52, but also between the scanning-side address electrodes 51 and the first electrodes 2 forming as the signal-side address electrodes. In this case, discharge between the electrodes 51 and the electrode 2 is started at a lower voltage because of a shorter distance between electrodes. Therefore, this discharge functions as a trigger, so that discharge between the electrodes 51 and the electrodes 52 is facilitated. At this time, if the area of the opening portion of the through-hole 7 is made to satisfy the condition described with respect to the fourth embodiment, i.e., if the effective discharge area of the first electrodes 2 determined by the opening portion area is made smaller than the effective discharge area of the second electrodes 5, then the trigger discharge is minute and so the main discharge between he electrodes 51 and 52 is not disturbed.

Moreover, the trigger pulses applied to the first electrodes 2 in the sustaining discharge interval may be the same as the sustaining pulses applied to the sustaining electrode 52 as described above. However, it is also possible to apply an optimum waveform depending on the structure and the circuit arrangement, which is narrowed in pulse width to decrease the trigger discharge current for example. Furthermore, as a method of sustaining, the electrodes 52 is kept at, for example, 0 v and sustaining pulses having positive and negative amplitudes may be applied to the electrodes 51 in some cases. In this case, by keeping the electrodes 2 also 0 v in the same way as the electrodes 52, similar operation is performed.

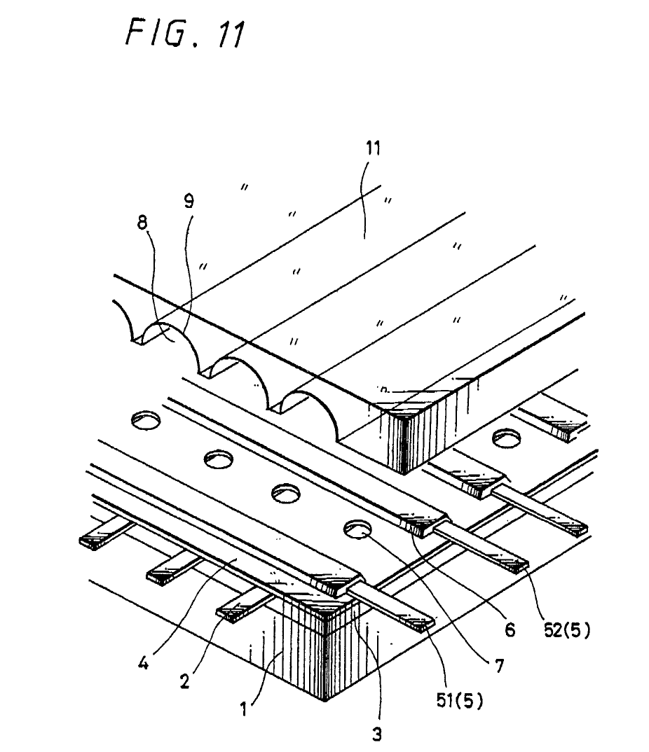

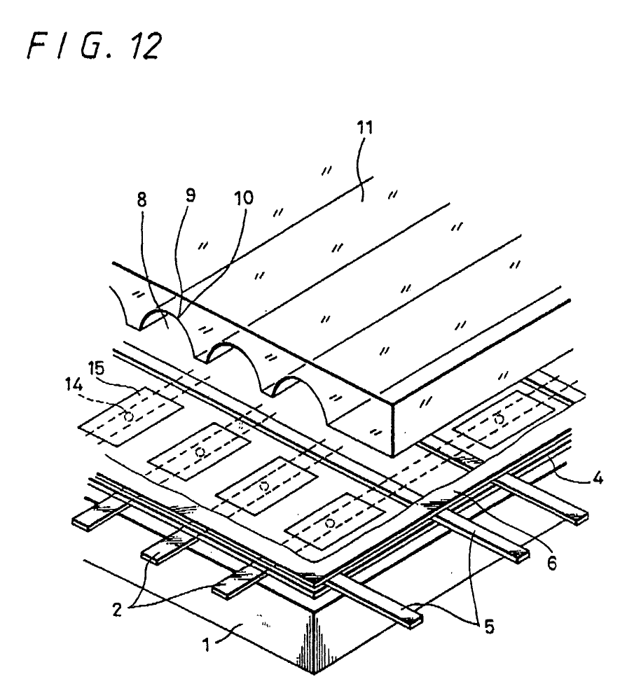

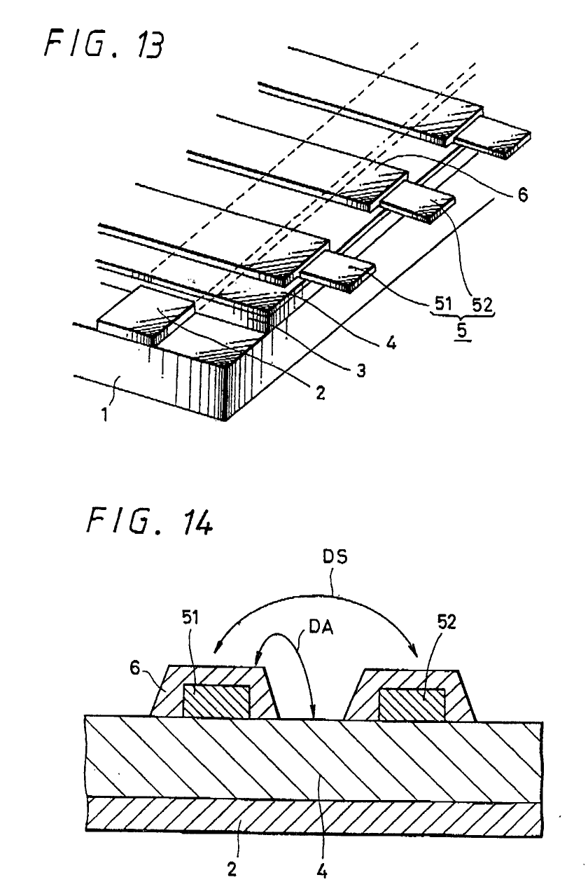

A discharge display device of a ninth embodiment according to the present invention will be described below with reference to FIG. 11. In this discharge display device, a new structure is added to the structures of the first to fourth embodiments.

In FIG. 11, a front-side glass substrate 11 is provided relative to the back-side glass substrate 1 having various electrodes formed thereon shown in FIGS. 1, 2 and 3. On the front-side glass substrate 1, a plurality of stripe-shaped or grid-shaped grooves 8 are formed using a method of working the glass substrate itself, such as the sand blast or the chemical etching. Then, a fluorescent material is coated on the internal wall surface of the grooves 8 to form a fluorescent material layer 9. Thereafter, both of the glass substrates 1 and 11 are opposed to each other with uniform spacing therebetween. The periphery is vacuum-sealed by means of glass frit. Mixed gas such as neon, argon, or xenon required for gas discharge is sealed therein. In this way, a color single-substrate type discharge display device is completed.

The structure of the ninth embodiment is characterized in that a plurality of stripe-shaped or grid-shaped grooves 8 are formed on the front-side glass substrate 11 using a method of working the glass substrate itself, such as sand blast or chemical etching, and the fluorescent material layer 9 for emitting light of a color corresponding to each pixel is formed on the internal wall surface of each groove 8.

Such a front-side glass substrate 11 can be applied to the single-substrate type discharge display device in which all necessary electrodes are provided on the back-side glass substrate 1 side of the back face side as in the aforementioned first to fourth embodiments.

In this case, no electrode is provided on the front-side glass substrate 11. In addition, a rib in the middle of each groove of the front-side .glass substrate 11 can be made transparent. Therefore, light emitted from the fluorescent material layer 9 can be emitted forward from the front-side glass substrate 11 efficiently. Besides, light from the front-side face of the glass substrate 11 which is close to the negative glow and is most apt to undergo ultraviolet irradiation can also be emitted forward efficiently. This makes high luminance display possible. Furthermore, coating of the fluorescent material on the front-side glass substrate 11 can be selected regardless of the electrodes. In addition, the shapes of electrodes themselves and positional relations, such as distances, between the fluorescent material layer 9 and the electrodes can be designed so as to be optimum regardless of the electric characteristics. Therefore, it will be possible to maximize the ultraviolet irradiation efficiency, i.e., the light emission efficiency of the fluorescent material layer 9 while keeping the driving characteristics best.

Advantageous effects of the present invention will now be described.

According to a first invention, a single-substrate type discharge display device comprises: first electrodes formed by a plurality of stripe-shaped electrodes formed in parallel to each other on a glass substrate; a first dielectric layer formed on the glass substrate so as to cover the first electrode; an insulation layer formed on the first dielectric layer, the insulation layer being made of a material that is lower in dielectric constant than the first dielectric layer; second electrodes formed by a plurality of stripe-shaped electrodes formed on the insulation layer in parallel to each other so as to cross the plurality of stripe-shaped electrodes forming the first electrodes; a plurality of through-holes provided in such positions, in every space between the plurality of stripe-shaped electrodes forming the second electrode as to respectively correspond to the plurality of stripe-shaped electrodes forming the first electrodes and bored into the insulation layer so as to reach the surface of the first dielectric layer; and a second dielectric layer formed on the insulation layer so as to cover the plurality of stripe-shaped electrodes forming the second electrodes. As a result, it is possible to obtain a single-substrate type discharge display device that is simple in structure, easy in fabrication, and low in price as compared with the conventional two-substrate type discharge display device, that is easy in address discharge using an X-Y matrix as compared with the conventional single-substrate type discharge display device, and that is capable of lowering the discharge voltage.

According to a second invention, in the single-substrate type discharge display device of the first invention, stripe-shaped electrodes forming the second electrodes are formed by pairs of stripe-shaped electrodes disposed in parallel to each other and connected electrically on the outside. Therefore, the advantageous effects of the first invention are obtained and besides, because each pair of stripe-shaped electrodes forming in the second electrodes can be handled as two electrodes, it is not necessary to carry out interlace driving which lowers the resolution. As a result, a single-substrate type discharge device capable of reducing the structure of the driving circuit can be obtained.

According to a third invention, in the single-substrate type discharge display device of the first invention, there are provided a plurality of through-holes disposed in such positions in every space or every other space between the plurality of stripe-shaped electrodes forming the second electrodes, as to respectively correspond to the plurality of stripe-shaped electrodes forming the first electrodes and bored so as to reach the surface of the first dielectric layer and extend over stripe-shaped electrodes on both sides thereof forming the second electrodes and into the insulation layer. Therefore, in addition to the effects of the first invention, because the space between the address electrode and the sustaining electrode does not become wide, even if the through-holes are located between both electrodes (address electrode and sustaining electrode), there can be obtained such a single-substrate type discharge display device that has low discharge voltages of the address discharge and the sustaining discharge and provides stable operation.

According to a fourth invention, in the single-substrate type discharge display device of the second invention, there are provided a plurality of through-holes disposed in such positions, in every space or every other space between the plural pairs of stripe-shaped electrode forming the second electrodes, as to respectively correspond to the plurality of stripe-shaped electrodes forming the first electrodes and bored so as to reach the surface of the first dielectric layer and extend over stripe-shaped electrodes on both sides thereof forming the second electrodes and the into insulation layer. Therefore, in addition to the effects of the second invention, because the space between the address electrode and the sustaining electrode does not become wide, even if the through-holes are located between both electrodes (address electrode and sustaining electrode), there can be obtained such a single-substrate type discharge display device that has low discharge voltages of the address discharge and the sustaining discharge does not ,become and provides stable operation.

According to a fifth invention, in the single-substrate type discharge display device of the first, second, third or fourth invention, because an effective discharge area of the first electrodes determined by the through-holes is set so as to be smaller than an effective discharge area of the second electrodes, in addition to the effects of the first, second, third or fourth invention, at the time of sustaining discharge, trigger discharge can be caused at the address electrodes prior to the discharge between the address electrode and the sustaining electrodes. As a result, there can be obtained such a single-substrate type discharge display device that, even if the space between the address electrode and the sustaining electrode is wide, the discharge voltage does not go high and stable operation is attained.

According to sixth, seventh, eighth, ninth, and tenth inventions, such a driving method of the single-substrate type discharge display devices of the first, second, third, fourth and fifth invention is provided that comprised the steps of: using one electrode of a pair (two pairs) of stripe-shaped electrodes on both sides of the through-hole out of in the plurality (plural pairs) of stripe-shaped electrodes forming the second electrode as an address electrodes that forms an X-Y matrix in cooperation with the first electrodes, and using the other electrode as a sustaining electrode connected in common to pixels; At time of address discharge, applying scanning address pulses to the address electrodes sequentially, applying simultaneously therewith a voltage on such a level as not to start discharge between the sustaining electrode and the address electrode to which the scanning address pulse is applied, to each of the sustaining electrodes applying address pulses depending on an image signal to the first electrodes in synchronism with the scanning address pulses to cause discharge, using the discharge as trigger discharge to cause address discharge between the address electrodes and the sustaining electrode, and thereby forming wall charges individually for each pixel; and at time of following sustaining discharge, applying sustaining pulses between the address electrode and the sustaining electrode by utilizing the wall charges formed during the address interval, and thereby continuously causing sustaining discharge. Therefore, in a driving method of causing address discharge by giving a voltage to each of the first electrodes in such a state that a voltage cannot that start discharge by the address electrode and the sustaining electrode alone is applied, there can be obtained such a driving method that, because there are through-holes between the address electrode and the sustaining electrodes and consequently trigger discharge is caused securely and address driving by low voltage is made possible.

According to an eleventh invention, a driving method of the single-substrate type discharge display device of the first invention is provided that comprises the steps of:

using one electrode of a pair of stripe-shaped electrodes on both sides of the through-hole out of the plurality of stripe-shaped electrodes forming the second electrodes as an address electrode that forms an X-Y matrix in cooperation with the first electrodes, using the other electrode as a sustaining electrode, connected in common to pixels, connecting the sustaining electrodes in common alternately to first and second connection lines, and thereby dividing the sustaining electrodes into two groups; and at time of address discharge, switching over a voltage applied to the first and second connection lines, thereby selecting which of the two sustaining electrodes adjacent to each address electrode should be discharged, and making interlace display using scanning line interlace driving. Therefore, by connecting the sustaining electrodes in common alternately to yield two groups, dividing them into even-numbered and odd-numbered fields, and switching over them for performing interlace driving, therefore, there can be obtained such a driving method of single-substrate type discharge display device that the circuit scale of the scanning-side driving circuit can be reduced by half and the price can be lowered.

According to a twelfth invention, a driving method of the single-substrate type discharge display devices of the first invention is provided that comprises the steps of:

in two pairs of stripe-shaped electrodes on both sides of the through-hole out of the plural pairs of stripe-shaped electrodes forming said second electrodes as an address electrode that forms an X-Y matrix in cooperation with the first electrodes, using the other pair of electrodes as a sustaining electrode connected in common to pixels, connecting the sustaining electrodes in common alternately to first and second connection lines, and thereby dividing the sustaining electrodes into two groups; and switching over a voltage of the first and second connection lines in accordance with timing of scanning address pulses applied to the address electrodes at time of addressing, causing address discharge and sustaining discharge by handling said address electrodes and sustaining electrode as two independent electrodes, and making non-interlace display by using sequential scanning driving. Therefore, there can be obtained such a driving method of the single-substrate type discharge display device that the circuit scale of the scanning-side driving circuit can be reduced by half without using the interlace driving and consequently the price can be lowered without lowering the resolution and luminance.

According to a thirteenth invention, in the driving methods of the single-substrate type discharge display devices of the sixth to twelfth inventions, in a pixel selected by address discharge, sustaining discharge is caused between the address electrode serving as a Y electrode and the sustaining electrode serving as a Z electrode, which are parallel to each other, in a sustaining discharge interval following the address interval. In the sustaining interval, a voltage of the first electrode serving as an X electrode is kept at the same voltage as that of the sustaining electrode or the same sustaining pulse is applied to the first electrode to cause trigger discharge that assists the sustaining discharge between that address electrode and said sustaining electrode. Thus, if in the sustaining interval, prior to the sustaining discharge between the scanning-side address electrode and the sustaining electrode the same sustaining pulse as that of the sustaining electrode is applied to the signal side address electrode as well or the signal side address electrode is kept at the same fixed potential as that of the sustaining electrode. Therefore, trigger discharge can be caused between the scanning-side address electrode and the signal-side address electrode. As a result, there can be obtained such a driving method of the single-substrate type discharge display device that, even if the space between the address electrode and the sustaining electrode is wide, the discharge voltage does not go high and stable operation is attained.

According to fourteenth to eighteenth inventions, in the single-substrate type discharge display devices of the first to fifth inventions, there is provided a front-side glass substrate opposed to the back-side glass substrate, a plurality of stripe-shaped or grid-shaped grooves being formed on the front-side glass substrate by working the glass substrate itself, and also a fluorescent material layer for emitting light of a color corresponding to each pixel being formed on an internal wall face of each groove. Therefore, the in addition to effects of the first to fifth inventions, the following effects are obtained. That is, electrodes are not provided on the glass substrate side of the front face side. In addition, a rib in the middle of each groove of front-side the glass substrate side of the can be made transparent. Therefore, light emitted from the fluorescent material layer can be emitted forward from the front-side glass substrate of the front face side efficiently. In addition, light from the side face of the front-side glass substrate which is in the vicinity of the negative glow and which is most susceptible to undergo ultraviolet irradiation can also be emitted forward efficiently. As a result, display in high light-emission efficiency and high luminance is enabled. Moreover, coating of the fluorescent material on the front-side glass substrate can be selected regardless of the electrodes. Furthermore, the shapes of electrodes themselves and positional relations, such as distances, between the fluorescent material layer and the electrodes can be designed most appropriately regardless of the electric characteristics. Therefore, it is possible to maximize the ultraviolet irradiation efficiency, i.e., the light emission efficiency of the fluorescent material layer while keeping the driving characteristics best.

### DESCRIPTION OF REFERENCE NUMERALS

1: BACK-SIDE GLASS SUBSTRATE

2: FIRST ELECTRODE

3: FIRST DIELECTRIC LAYER

4: INSULATION LAYER

5: SECOND ELECTRODE

6: SECOND DIELECTRIC LAYER

7: THROUGH-HOLE

8: GROOVE

9: FLUORESCENT MATERIAL LAYER

11: FRONT-SIDE GLASS SUBSTRATE

51: ADDRESS ELECTRODE

52: SUSTAINING ELECTRODE

1. A single-substrate type discharge display device characterized by comprising:
first electrodes formed by a plurality of stripe-shaped electrodes formed in parallel to each other on a glass substrate;
a first dielectric layer formed on said glass substrate so as to cover said first electrodes;
an insulation layer formed on said first dielectric layer, said insulation layer being made of a material that is lower in dielectric constant than said first dielectric layer;
second electrodes formed by a plurality of stripe-shaped electrodes formed on said insulation layer in parallel to each other so as to cross the plurality of stripe-shaped electrodes forming said first electrodes;
a plurality of through-holes provided in such positions, in every space between the plurality of stripe-shaped electrodes forming said second electrodes, as to respectively correspond to the plurality of stripe-shaped electrodes forming said first electrodes and bored in said insulation layer so as to reach the surface of said first dielectric layer; and
a second dielectric layer formed on said insulation layer so as to cover the plurality of stripe-shaped electrodes forming said second electrodes.

2. The single-substrate type discharge display device according to claim 1, characterized in that
each of said stripe-shaped electrodes forming said second electrodes is comprised of a pair of stripe-shaped electrodes disposed in parallel to each other and electrically connected on the outside.

3. A single-substrate type discharge display device characterized by comprising:
first electrodes formed by a plurality of stripe-shaped electrodes formed in parallel to each other on a glass substrate;
a first dielectric layer formed on said glass substrate so as to cover said first electrodes;
an insulation layer formed on said first dielectric layer, said insulation layer being made of a material that is lower in dielectric constant than said first dielectric layer;
second electrodes formed by a plurality of stripe-shaped electrodes formed on said insulation layer in parallel to each other so as to cross the plurality of stripe-shaped electrodes forming said first electrodes;
a plurality of through-holes provided in such positions, in every space or every other space between the plurality of stripe-shaped electrodes forming said second electrodes, as to respectively correspond to the plurality of stripe-shaped electrodes forming said first electrodes and bored so as to reach the surface of said first dielectric layer and extend over stripe-shaped electrodes on both sides thereof forming said second electrodes and into said insulation layer; and
a second dielectric layer formed on said insulation layer so as to cover the plurality of stripe-shaped electrodes forming said second electrodes.

4. A single-substrate type discharge display device characterized by comprising:
first electrodes formed by a plurality of stripe-shaped electrodes formed in parallel to each other on a glass substrate;
a first dielectrics layer formed on said glass substrate so as to cover said first electrodes;
an insulation layer formed on said first dielectric layer, said insulation layer being made of a material that is lower in dielectric constant than said first dielectric layer;
second electrodes formed by plural pairs of stripe-shaped electrodes that are formed on said insulation layer in parallel to each other so as to cross the plurality of stripe-shaped electrodes forming said first electrodes, and connected electrically on the outside;
a plurality of through-holes provided in such positions, in every space or every other space between the plural pairs of stripe-shaped electrodes forming said second electrodes as to respectively correspond to the plurality of stripe-shaped electrodes forming said first electrodes and bored so as to reach the surface of said first dielectric layer and extend over stripe-shaped electrodes on both sides thereof forming said second electrodes and into said insulation layer; and
a second dielectric layer formed on said insulation layer so as to cover the plural pairs of stripe-shaped electrodes forming said second electrodes.

5. The single-substrate discharge display device according to claim 1, 2, 3 or 4, characterized in that
an effective discharge area of said first electrodes determined by said through-holes is set so as to be smaller than an effective discharge area of said second electrodes.

6. A driving method of a single-substrate type discharge display device comprising:
first electrodes formed by a plurality of stripe-shaped electrodes formed in parallel to each other on a glass substrate;
a first dielectric layer formed on said glass substrate so as to cover said first electrode;
an insulation layer formed on said first dielectric layer, said insulation layer being made of a material that is lower in dielectric constant than said first dielectric layer;
second electrodes formed by plural pairs of stripe-shaped electrodes formed on said insulation layer in parallel to each other so as to cross the plurality of stripe-shaped electrodes forming said first electrodes, and connected electrically on the outside;
a plurality of through-holes provided in such positions, in every space between the plural pairs of stripe-shaped electrodes forming said second electrodes, as to respectively correspond to the plurality of stripe-shaped electrodes forming said first electrodes and bored in said insulation layer so as to reach the surface of said first dielectric layer; and
a second dielectric layer formed on said insulation layer so as to cover the plurality of stripe-shaped electrodes forming said second electrodes,
the driving method being characterized by comprising the steps of:
using one pair of electrode in two pairs of stripe-shaped electrodes on both sides of said through-hole out of plural pairs of stripe-shaped electrodes forming said second electrodes as an address electrode that forms an X-Y matrix in cooperation with said first electrodes, and using the other pair of electrode as a sustaining electrode connected in common to pixels;
at time of address discharge, applying scanning address pulses to said address electrodes sequentially, applying simultaneously therewith a voltage on such a level as not to start discharge between said sustaining electrode and said address electrode to which said scanning address pulse is applied, to said sustaining electrodes, applying address pulses depending on an image signal to said first electrodes in synchronism with said scanning address pulses to cause discharge, using said discharge as trigger discharge to cause address discharge between said address electrode and said sustaining electrode, and thereby forming wall charges individually for each pixel; and
at time of following sustaining discharge, applying sustaining pulses between said address electrodes and said sustaining electrodes by utilizing the wall charges formed during the address interval and thereby continuously causing sustaining discharge.

7. A driving method of a single-substrate type discharge display device comprising:
first electrodes formed by a plurality of stripe-shaped electrodes formed in parallel to each other on a glass substrate;
a first dielectric layer formed on said glass substrate so as to cover said first electrode;
an insulation layer formed on said first dielectric layer, said insulation layer being made of a material that is lower in dielectric constant than said first dielectric layer;
second electrodes formed by plural pairs of stripe-shaped electrodes formed on said insulation layer sin parallel to each other and cross the plurality of stripe-shaped electrodes forming said first electrodes, and connected electrically on the outside;
a plurality of through-holes provided in such positions, in every space between the plural pairs of stripe-shaped electrode forming said second electrodes, as to respectively correspond to the plurality of stripe-shaped electrodes forming said first electrodes and bored in said insulation layer so as to reach the surface of said first dielectric layer; and
a second dielectric layer formed on said insulation layer so as to cover the plurality of stripe-shaped electrodes forming said second electrodes,
the driving method being characterized by comprising the steps of:
using one pair of electrodes in two pairs of stripe-shaped electrodes on both sides of said through-hole out of the plural pairs of stripe-shaped electrodes forming said second electrode as an address electrode that forms an X-Y matrix in cooperation with said first electrodes, and using electrodes set as a sustaining electrode connected in common to pixels;
at time of address discharge, applying scanning address pulses to said address electrodes sequentially, applying simultaneously therewith a voltage on such a level as not to start discharge between said sustaining electrode and said address electrode to which said scanning address pulse is applied, to said sustaining electrodes;
applying address pulses depending on an image signal to said first electrodes in synchronism with said scanning address pulses to cause discharge, using said discharge as trigger discharge to cause address discharge between said address electrode and said sustaining electrode, and thereby forming wall charges individually for each pixel; and
at time of following sustaining discharge, applying sustaining pulses between said address electrodes and said sustaining electrodes by utilizing the wall charges formed during the address interval and thereby continuously causing sustaining discharge.

8. A driving method of a single-substrate type discharge display device comprising:
first electrodes formed by a plurality of stripe-shaped electrodes formed in parallel to each other on a glass substrate;
a first dielectric layer formed on said glass substrate so as to cover said first electrode;
an insulation layer formed on said first dielectric layer, said insulation layer being made of a material that is lower in dielectric constant than said first dielectric layer;
second electrodes formed by a plurality of stripe-shaped electrodes formed on said insulation layer in parallel to each other so as to cross the plurality of stripe-shaped electrodes forming said first electrodes;
a plurality of through-holes provided in such positions, in every space or every other space between the plurality of stripe-shaped electrodes forming said second electrodes, as to respectively correspond to the plurality of stripe-shaped electrodes forming said first electrodes and bored so as to reach the surface of said first dielectric layer and extend over stripe-shaped electrodes on both sides thereof forming said second electrodes and into said insulation layer; and
a second dielectric layer formed on said insulation layer so as to cover the plurality of stripe-shaped electrodes forming said second electrodes,
the driving method being characterized by comprising the steps of:
using one electrode of a pair of stripe-shaped electrodes on both sides of said through-hole out of the plurality of stripe-shaped electrodes forming said second electrodes as an address electrode that forms an X-Y matrix in cooperation with said first electrodes, and using the other electrode as a sustaining electrode connected in common to pixels;
at time of address discharge, applying scanning address pulses to said address electrodes sequentially, and applying simultaneously therewith a voltage on such a level as not to start discharge between said sustaining electrode and said address electrode to which said scanning address pulse is applied, to said sustaining electrodes; applying address pulses depending on an image signal to said first electrodes in synchronism with said scanning address pulses to cause discharge, using said discharge as trigger discharge to cause address discharge between said address electrode and said sustaining electrode, and thereby forming wall charges individually for each pixel; and
at time of following sustaining discharge, applying sustaining pulses between said address electrodes and said sustaining electrodes by utilizing the wall charges formed during the address interval and thereby continuously causing sustaining discharge.

9. A driving method of a single-substrate type discharge display device comprising;
first electrodes formed by a plurality of stripe-shaped electrodes formed in parallel to each other on a glass substrate;
a first dielectric layer formed on said glass substrate so as to cover said first electrode;
an insulation layer formed on said first dielectric layer, said insulation layer being made of a material that is lower in dielectric constant than said first dielectric layer;
second electrodes formed by plural pairs of stripe-shaped electrodes formed on said insulation layer in parallel to each other so as to cross the plurality of stripe-shaped electrodes forming said first electrodes, and connected electrically on the outside;
a plurality of through-holes provided in such positions, in every space or every other space between the plural pairs of stripe-shaped electrodes forming said second electrodes, as to respectively correspond to the plurality of stripe-shaped electrodes forming said first electrodes and bored so as to reach the surface of said first dielectric layer and extend over stripe-shaped electrodes on both sides thereof forming said second electrodes and into said insulation layer; and
a second dielectric layer formed on said insulation layer so as to cover the plural pairs of stripe-shaped electrodes forming said second electrodes,
the driving method being characterized by comprising the steps of:
using one pair of electrodes in two pairs of stripe-shaped electrodes on both sides of said through-hole out of the plural pairs of stripe-shaped electrodes forming said second electrodes as an address electrode that forms an X-Y matrix in cooperation with said first electrodes, and using the other pair of electrodes as a sustaining electrode connected in common to pixels;
at time of address discharge, applying scanning address pulses to said address electrodes sequentially, applying simultaneously therewith a voltage on such a level as not to start discharge between said sustaining electrode and said address electrode to which said scanning address pulse is applied, to said sustaining electrodes,
applying address pulses depending on an image signal to said first electrodes in synchronism with said scanning address pulses to cause exciting discharge, using said discharge as trigger discharge to cause address discharge between said address electrode and said sustaining electrode, and thereby forming wall charges individually for each pixel; and
at time of following sustaining discharge, applying sustaining pulses between said address electrodes and said sustaining electrodes by utilizing the wall charges formed during the address interval and thereby continuously exciting sustaining discharge.

10. A driving method of a single-substrate type discharge display device according to claim 6, 7, 8 or 9, characterized in that
an effective discharge area of said first electrodes determined by said through-holes is set so as to be smaller than an effective discharge area of said second electrodes.

11. A driving method of a single-substrate type discharge display device comprising:
first electrodes formed by a plurality of stripe-shaped electrodes formed in parallel to each other on a glass substrate;
a first dielectric layer formed on said glass substrate so as to cover said first electrode;
an insulation layer formed on said first dielectric layer, said insulation layer being made of a material that is lower in dielectric constant than said first dielectric layer;
second electrodes formed by a plurality of stripe-shaped electrodes formed on said insulation layer in parallel to each other so as to cross the plurality of stripe-shaped electrodes forming said first electrodes;
a plurality of through-holes provided in such positions, in every space between the plurality of stripe-shaped electrodes forming said second electrodes, as to respectively correspond to the plurality of stripe-shaped electrodes forming said first electrodes and bored in said insulation layer so as to reach the surface of said first dielectric layer; and
a second dielectric layer formed on said insulation layer so as to cover the plurality of stripe-shaped electrodes forming said second electrodes,
the driving method being characterized by comprising the steps of:
using one electrode of a pair of stripe-shaped electrodes on both sides of said through-hole out of the plurality of stripe-shaped electrodes forming said second electrodes as an address electrode that forms an X-Y matrix in cooperation with said first electrodes, using the other electrode as a sustaining electrode connected in common to pixels, connecting said sustaining electrodes in common alternately to first and second connection lines, and thereby dividing said sustaining electrodes into two groups; and
at time of address discharge, switching over a voltage applied to said first and second connection lines, thereby selecting which of the two sustaining electrodes adjacent to said address electrode should be discharged, and performing interlace display using scanning line interlace driving.

12. A driving method of a single-substrate type discharge display device comprising:
first electrodes formed by a plurality of stripe-shaped electrodes formed in parallel to each other on a glass substrate;
a first dielectric layer formed on said glass substrate so as to cover said first electrode;
an insulation layer formed on said first dielectric layer, said insulation layer being made of a material that is lower in dielectric constant than said first dielectric layer;
second electrodes formed by plural pairs of stripe-shaped electrodes formed on said insulation layer in parallel to each other so as to cross the plurality of stripe-shaped electrodes forming said first electrodes, and connected electrically on the outside;
a plurality of through-holes provided in such positions, in every space between the plurality of stripe-shaped electrodes forming said second electrodes, as to respectively correspond to the plurality of stripe-shaped electrodes forming said first electrodes and bored in said insulation layer so as to reach the surface of said first dielectric layer; and
a second dielectric layer formed on said insulation layer so as to cover the plurality of stripe-shaped electrodes forming said second electrodes,
the driving method being characterized by comprising the steps of:
using one pair of electrodes in two pairs of stripe-shaped electrodes on both sides of said through-hole out of the plural pairs of stripe-shaped electrodes forming said second electrode as an address electrodes that forms an X-Y matrix in cooperation with said first electrodes, using the other pair of electrodes as a sustaining electrode connected in common to pixels, connecting said sustaining electrodes in common alternately to first and second connection lines, and thereby dividing said sustaining electrodes into two groups; and
switching over a voltage of said first and second connection lines in accordance with timing of scanning address pulses applied to said address electrodes at time of addressing, causing address discharge and sustaining discharge by handling said address electrode and said sustaining electrode as two independent electrodes, and performing non-interlace display by sequential scanning driving.

13. A driving method of a single-substrate type discharge display device according to any one of claims 6 to 12, characterized in that
in a pixel selected by address discharge, sustaining discharge is performed between said address electrode serving as a Y electrode and said sustaining electrode serving as a Z electrode, which are parallel to each other, in a sustaining discharge interval following the address interval, and
in the sustaining interval, a voltage of said first electrode serving as an X electrode is kept at the same voltage as that of said sustaining electrode or the same sustaining pulse is applied to said first electrode to cause trigger discharge that assists the sustaining discharge between said address electrode and said sustaining electrode.

14. A color single-substrate type discharge display device characterized by comprising;
first electrodes formed by a plurality of stripe-shaped electrodes formed in parallel to each other on a back-side glass substrate;
a first dielectric layer formed on said back-side glass substrate so as to cover said first electrodes;
an insulation layer formed on said first dielectric layer, said insulation layer being made of a material that is lower in dielectric constant than said first dielectric layer;
second electrodes formed by a plurality of stripe-shaped electrodes formed on said insulation layer in parallel to each other so as to cross the plurality of stripe-shaped electrodes forming said first electrodes;
a plurality of through-holes provided in such positions, in every space between the plurality of stripe-shaped electrodes forming said second electrodes, as to respectively correspond to the plurality of stripe-shaped electrodes forming said first electrodes and bored in said insulation layer so as to reach the surface of said first dielectric layer;
a second dielectric layer formed on said insulation layer so as to cover the plurality of stripe-shaped electrodes forming said second electrodes; and
a front-side glass substrate opposed to said back-side glass substrate, wherein
a plurality of stripe-shaped or grid-shaped grooves are formed on said front-side glass substrate by working the glass substrate itself, and a fluorescent material layer for emitting light of a color corresponding to each pixel is formed on an internal wall face of each groove.

15. A color single-substrate type discharge display device characterized by comprising:
first electrodes formed by a plurality of stripe-shaped electrodes formed in parallel to each other on a back-side glass substrate;
a first dielectric layer formed on said back-side glass substrate so as to cover said first electrodes;
an insulation layer formed on said first dielectric layer, said insulation layer being made of a material that is lower in dielectric constant than said first dielectric layer;
second electrodes formed by plural pairs of stripe-shaped electrodes formed on said insulation layer in parallel to each other so as to cross the plurality of stripe-shaped electrodes forming said first electrodes, and connected electrically on the outside;
a plurality of through-holes provided in such positions, in every space between the plural pairs of stripe-shaped electrodes forming said second electrodes as to respectively correspond to the plurality of stripe-shaped electrodes forming said first electrodes and bored in said insulation layer so as to reach the surface of said first dielectric layer;
a second dielectric layer formed on said insulation layer so as to cover the plural pairs of stripe-shaped electrodes forming said second electrodes; and
a front-side glass substrate opposed to said back-side glass substrate, wherein
a plurality of stripe-shaped or grid-shaped grooves are formed on said front-side glass substrate by working the glass substrate itself, and a fluorescent material layer for emitting light of a color corresponding to each pixel is formed on an internal wall face of each groove.

16. A color single-substrate type discharge display device characterized by comprising:
first electrodes formed by plurality of stripe-shaped electrodes formed in parallel to each other on a back-side glass substrate;
first dielectric layer formed on said back-side glass substrate of back face side so as to cover said first electrodes;
an insulation layer formed on said first dielectric layer, said insulation layer being made of a material that is lower in dielectric constant than said first dielectric layer;
second electrodes formed by a plurality of stripe-shaped electrodes formed on said insulation layer in parallel to each other so as to cross the plurality of stripe-shaped electrodes forming said first electrodes;
a plurality of through-holes provided in such positions in every space or every other space between the plurality of stripe-shaped electrodes forming said second electrodes, as to respectively correspond to-the plurality of stripe-shaped electrodes forming said first electrodes and bored so as to reach the surface of said first dielectric layer and extend over stripe-shaped electrodes on both sides thereof forming said second electrodes and into said insulation layer;
a second dielectric layer formed on said insulation layer so as to cover the plurality of stripe-shaped electrodes forming said second electrodes; and
a front-side glass substrate opposed to said back-side glass substrate, and
a plurality of stripe-shaped or grid-shaped grooves are formed on said front-side glass substrate by working the glass substrate itself, and a fluorescent material layer for emitting light of a color corresponding to each pixel is formed on an internal wall face of each groove.

17. A color single-substrate type discharge display device characterized by comprising:
first electrodes formed by a plurality of stripe-shaped electrodes formed in parallel to each other on a glass substrate;
a first dielectric layer formed on said glass substrate so as to cover said first electrodes;
an insulation layer formed on said first dielectric layer, said insulation layer being made of a material that is lower in dielectric constant than said first dielectric layer;
second electrodes formed by plural pairs of stripe-shaped electrodes formed on said insulation layer in parallel to each other so as to cross the plurality of stripe-shaped electrodes forming said first electrodes, and connected electrically on the outside;
a plurality of through-holes provided in such positions, in every space or every other space between the plural pairs of stripe-shaped electrodes forming said second electrodes, as to respectively correspond to the plurality of stripe-shaped electrodes forming said first electrodes and bored so as to reach the surface of said first dielectric layer and extend over stripe-shaped electrodes on both sides thereof forming said second electrodes and into said insulation layer;
a second dielectric layer formed on said insulation layer so as to cover the plural pairs of stripe-shaped electrodes forming said second electrodes; and
a front-side glass substrate opposed to said back-side glass substrate, wherein
a plurality of stripe-shaped or grid-shaped grooves are formed on said front-side glass substrate by working the glass substrate itself, and a fluorescent material layer for emitting light of a color corresponding to each pixel is formed on an internal wall face of each groove.

18. A color single-substrate type discharge display device according to claim 14, 15, 16 or 17, characterized in that
an effective discharge area of said first electrodes determined by said through-holes is set so as to be smaller than an effective discharge area of said second electrodes.
